(19) United States
(12) Patent Application Publication
(10) Pub. No.: US 2019/0088166 A1
(43) Pub. Date: Mar. 21, 2019

(54) Emergency Contact Form

(71) Applicant: Dan Seidlitz, Grass Valley, CA (US)

(72) Inventor: Dan Seidlitz, Grass Valley, CA (US)

(21) Appl. No.: 15/709,128

(22) Filed: Sep. 19, 2017

(51) Int. Cl. G09F 3/02; A01K 11/00; B68B 5/00

(52) U.S. Cl. CPC G09F 3/02; B68B 1/02; B68B 5/00; A01K 11/00

(57) ABSTRACT

A personal identification tag described herein comprising a lightweight durable vinyl label that is an essential identification tool for all animal owners, sports equipment users, and travelers with luggage, in addition to many other identification uses. With your emergency information readily accessible, the identification tag is available in various configurations for securing the label to your existing halter, bridle, breast collar or saddle with its easy-to-use clip-on snap or sewn onto a braided nylon strap. In the case of manestay, the product with emergency contact form attaches directly to the equine's mane or tail hair. It is a further object of the present invention to provide an improved identification tool for use with luggage/backpacks, sports equipment, personal properties in additional to a specialty emergency contact form for adults and children. The emergency contact form organizes all of the important contact information in one convenient place and is easily accessible in case of trauma, theft, weather emergency, missing or loose pets. Various modifications may be made to the above described embodiment without departing from the scope of the invention.

### STATEMENT REGARDING FEDERALLY SPONSORED RESEARCH OR DEVELOPMENT

Not Applicable

### REFERENCE TO A “MICROFICHE APPENDIX”

Not Applicable.

### FIELD OF THE INVENTION

The present invention relates to a personal identification tag; and more particularly, to a emergency contact form which can be attach to animal, people, personal objects and many other identification uses.

### BACKGROUND OF THE INVENTION

There are many types of identification tags which can finally end the confusion over which animal and/or product belongs to which owner. All pets need to wear collars with identification tags, rabies vaccination tag and city or county licenses (where applicable). The identification tag should include the owner's name, address, telephone number and the pet's name.

An identification tag is even more important if you and your pets are traveling or moving. Pets have been known to get loose on airport tarmacs or at a roadside rest stop. You'll increase your chances of being reunited with pets who get lost by having this emergency contact form or halter emergency contact form as it organizes all of your pet's important information in one convenient place. In case of trauma, theft, weather emergency, missing or loose pets, travel, etc., this folding identification tag will help you be prepared.

Although the emergency contact form might appeal mainly to pet owners, there are other possible uses for it. For example, baggage carousels are frequently not guarded, so there's nothing to stop anyone from walking up to the carousel and helping themselves to bags that do not belong to them. Since you're separated from your checked bags for most of the trip, it's a good idea to do whatever you can to protect them while they are out of your sight.

In regards to other possibilities, if you have an elderly relative who lives alone and is frail, they could wear it when they go out in case they fall or become disoriented. It could also be an emergency contact form for children when you take them on holiday or to crowded places.

Iris scans, microchips and photos (4 sides) are excellent methods of identifying your pets. Microchip contains a unique identification number that can be read by a microchip scanner and match with owner information. A microchip is effective in reuniting a lost pet with his owner only when the owner's contact information in the microchip database is accurate. However, many of us have not chipped, scanned or photographed our pets. In addition, after your lost pet is found, it takes a scanner to read both the microchip and the iris so, the average citizen who finds your pet won't be able to scan for a chip, but they will probably be able to read a basic identification tag.

Livestock marking pens are waterproof crayons that are easy to smear on. These crayons seemed like a good item to have in the barn or the trailer. If all else failed, you could write just one colored swipe and at least whoever found your pet would be able to say it had a big blue patch on its right shoulder but the person who has the pet may not believe you. Therefore, unless you immediately register your pets or update your contact information promptly the crayons will become useless.

Pet tags seem like the ideal identification tag that would be an easy way to prepare for a disaster. The hard part would be getting the collar identification tag to stay on your pets during an emergency like a fire, tornado, hurricane or earthquake. Some people find the constant jingling of multiple tags (ID tag, rabies tag, license tag) a nuisance. The emergency contact form is made of soft flexible material and fits around the outside of the collar keeping it from clattering against other tags.

“Identification tattoos” are registered markings that can also help your pet find their way home. However tattoos can fade and become difficult to read. They can go unnoticed if the person who finds your pet doesn't think to check an ear or the inside of a thigh for a tattoo. Even if your pet is tattooed, an emergency contact form with current information will get your pet home quickly. There is no such thing as “too much identification.”

### DETAILED DESCRIPTION OF THE INVENTION

It is an object of the present invention to provide an improved identification tool for all pet owners, travelers, sport and fitness items, in addition to tools and equipment. emergency contact form is sturdy, removable custom identification tag which is constructed from the durable Ultra 18 z blockout banner pro waterproof material.

The durable nylon clip-on provides peace of mind knowing that if you are separated from your pet, you can be reunited later. Use a permanent marker to write your information on the emergency contact form, which is a waterproof material, and your information is permanent. This is a must-have for emergency situations, traveling or just as extra precaution on a fitness trail.

More specifically, identification clip-on is portable and can be moved from saddle to belt loop to your backpack or camera bag or your dog's crate or use it as a luggage tag. It's a great way to keep your and your horse's identification on him when you're away from home. Designed for use under the bridle, the identification halter emergency contact form is far less bulky than a standard nylon or rope halter. The identification halter emergency contact form enables the rider to lead or tie the bridled horse on the trail. Since it does not have a throatlatch, the identification halter tag alone should not be relied upon for tying a horse, particularly without supervision.

emergency contact form is very handy for identifying various types of equipment, from appliances, tools and machinery to tanks, valves and much more. The identification and labeling of equipment with emergency contact form is important to the continued health and well being of your workers.

Anyone who rides a bike, goes running or hiking, should not leave home without an emergency contact form. There is nothing high-tech about it. It just features your name, address and contact details screen printed onto a tag which can be used with a wristband, ankle band or dog tag.

Although it might appeal mainly to the fitness fans, there are other possible uses for it. For example, if you have an elderly relative who lives alone and is frail, they could wear it when they go out in case they fall or become lost. It could also be an emergency contact form attached to a belt loop for kids when you take them on holiday or to crowded places. Sure, you could write your name and address on a bit of paper and stick it in your pocket, but it wouldn't be as durable or visible.

### BRIEF DESCRIPTION OF THE DRAWING

FIG. 1 is substantially a perspective view of one embodiment of the emergency contact form showing the identification clip-on emergency contact form, identification halter emergency contact form, and identification pet collar emergency contact form, identification luggage emergency contact form, identification sport emergency contact form of the present invention.

FIG. 2 is substantially a perspective view of the identification tag elements incorporated in the present invention.

FIG. 3 is substantially a perspective view of the identification tag elements incorporated in the present invention.

FIG. 4 is substantially a perspective view of the relationship between components, in the closed position, of the present invention.

FIG. 5 is substantially a perspective view of the relationship between components, in the open position, of the present invention.

FIG. 6 is substantially an exploded view of the relationship between components of the present invention.

FIG. 7 is substantially a perspective view of the relationship between components, in the closed position, of the present invention.

FIG. 8 is substantially a perspective view of the relationship between components, in the open position, of the present invention.

FIG. 9 is substantially an exploded view of the relationship between components of the present invention.

FIG. 10 is substantially a perspective view of a flow chart on how to use the identification tag of the present invention.

FIG. 11 is substantially an isometric view of the luggage tag elements incorporated in the present invention.

FIG. 12 is substantially an isometric view of the sport tag elements incorporated in the present invention.

FIG. 13 is substantially a perspective view of a flow chart on how to use the identification halter tag of the present invention.

### DESCRIPTION OF CERTAIN EMBODIMENT OF THE PRESENT INVENTION

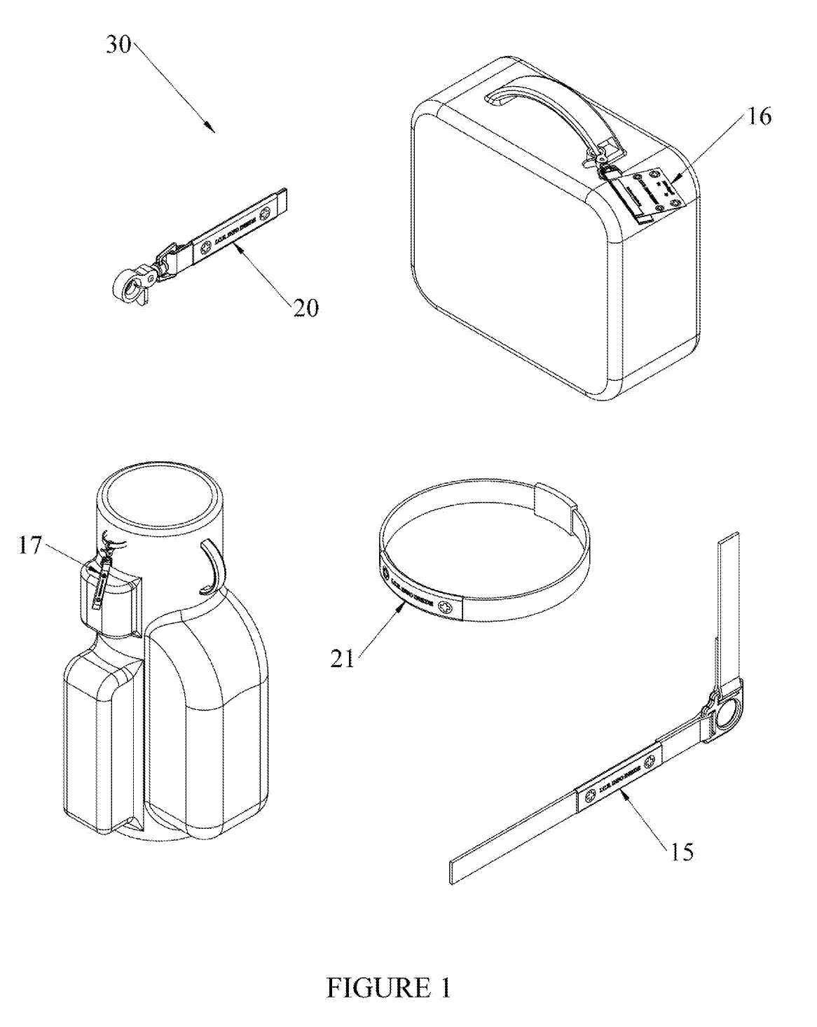

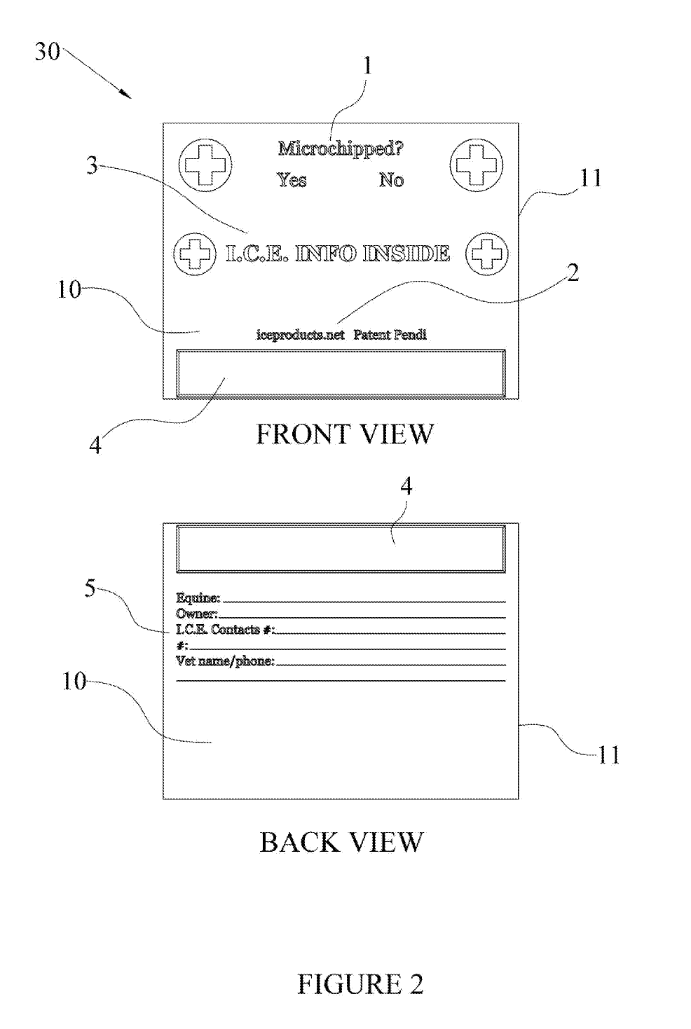

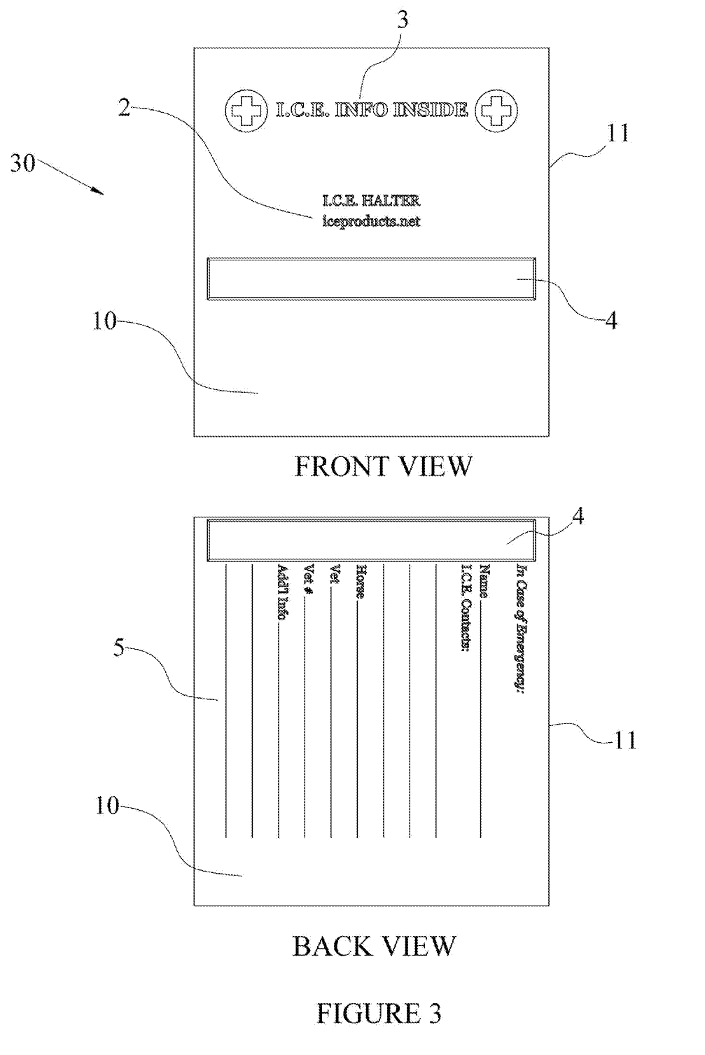

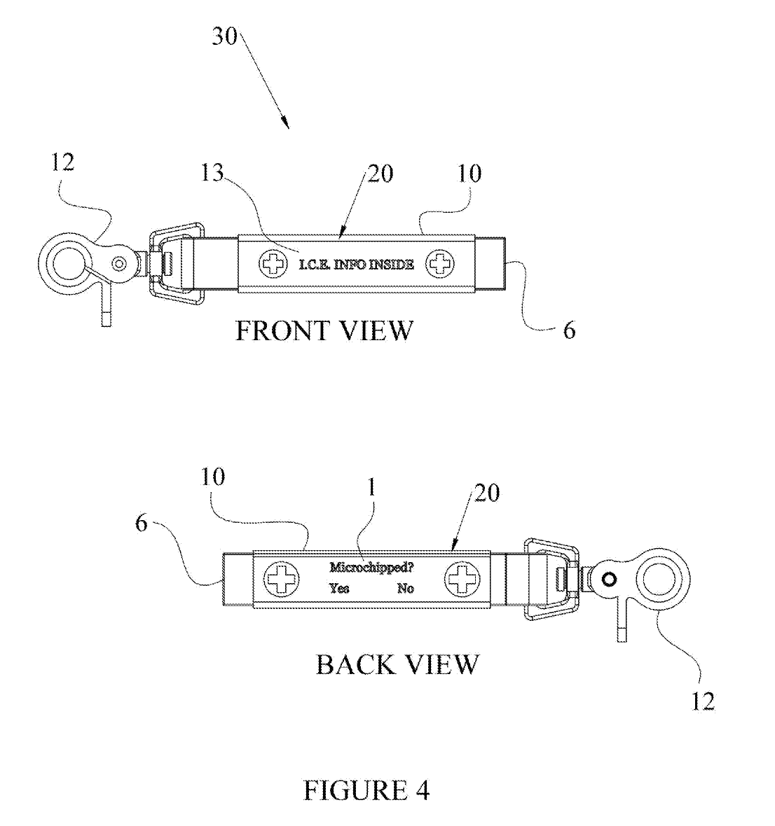

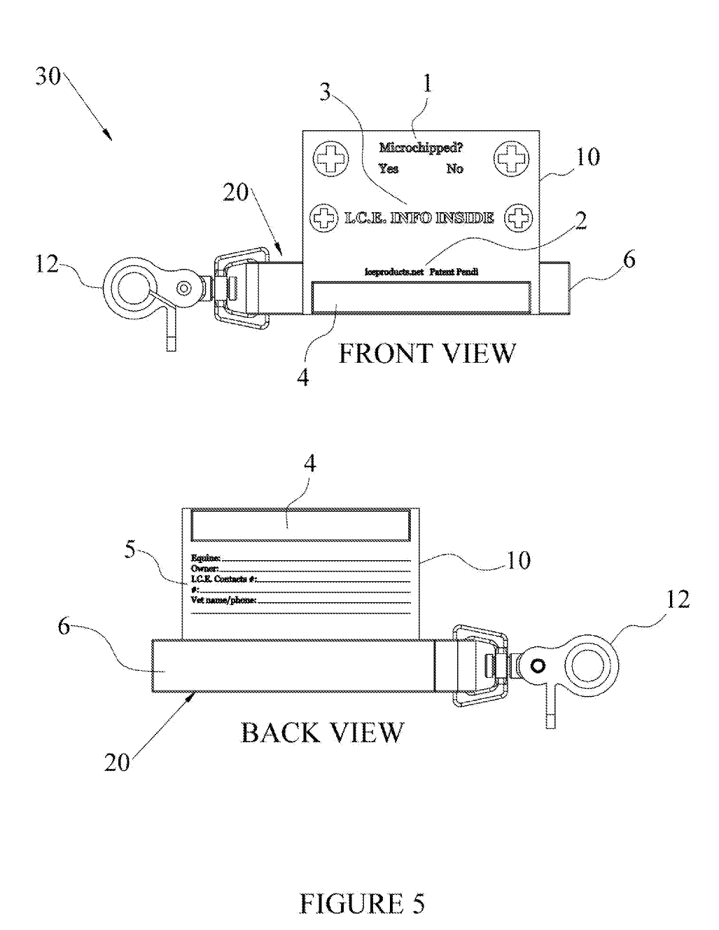

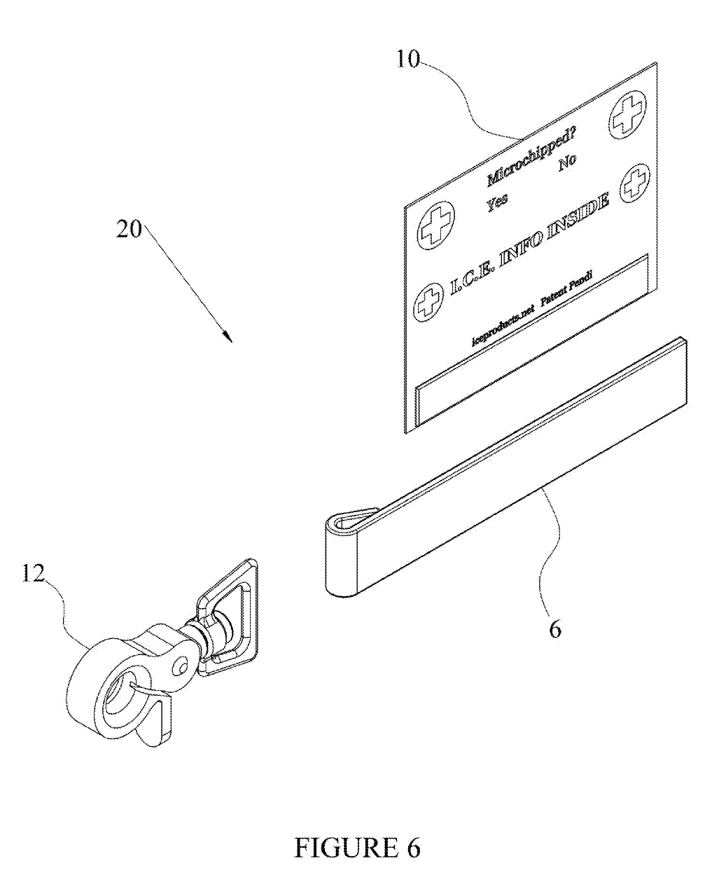

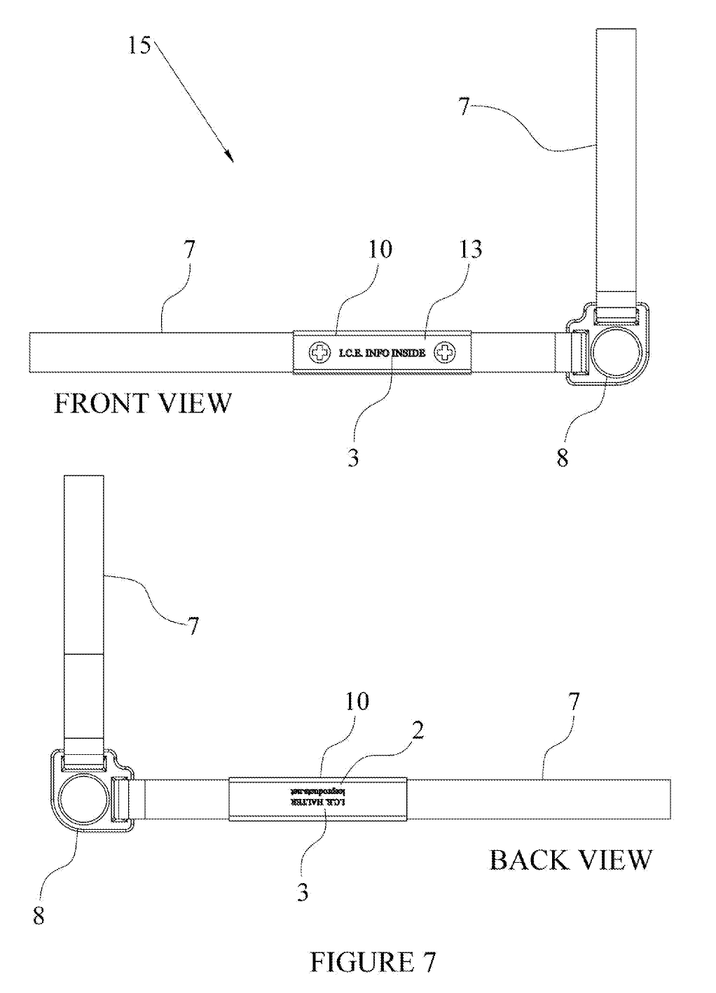

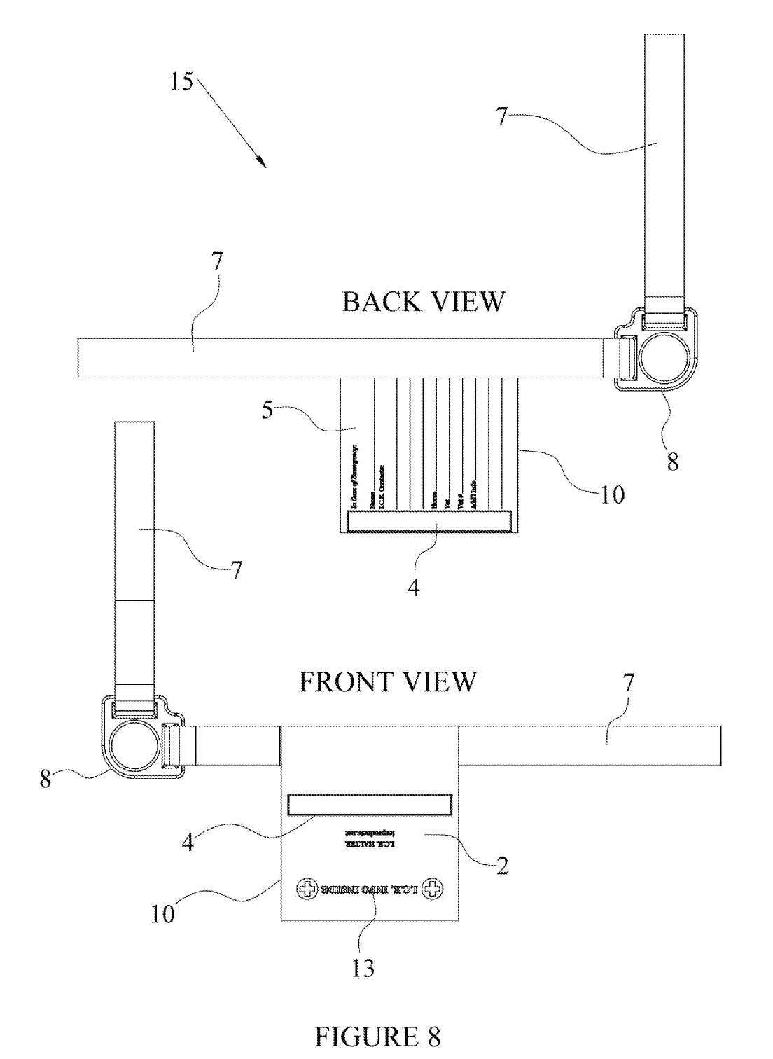

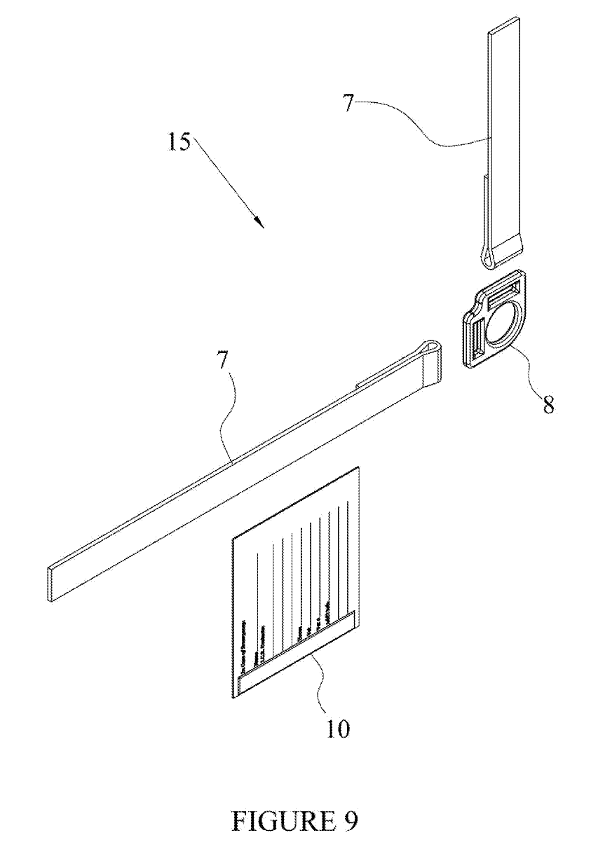

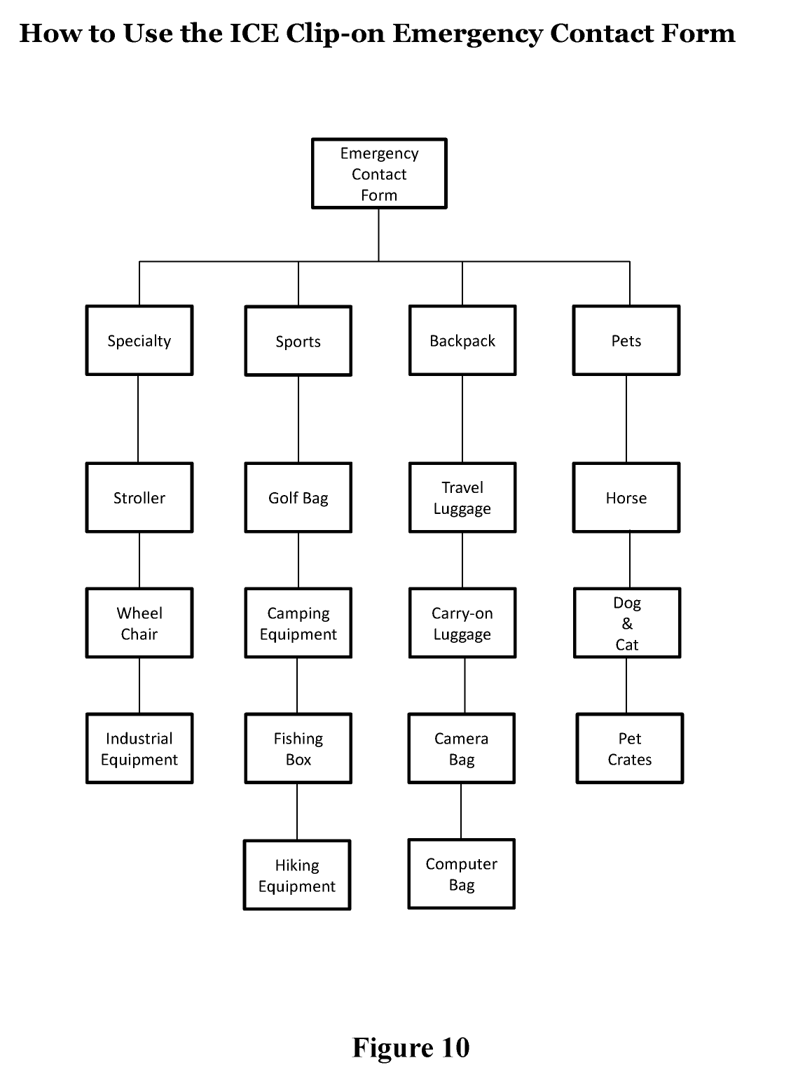

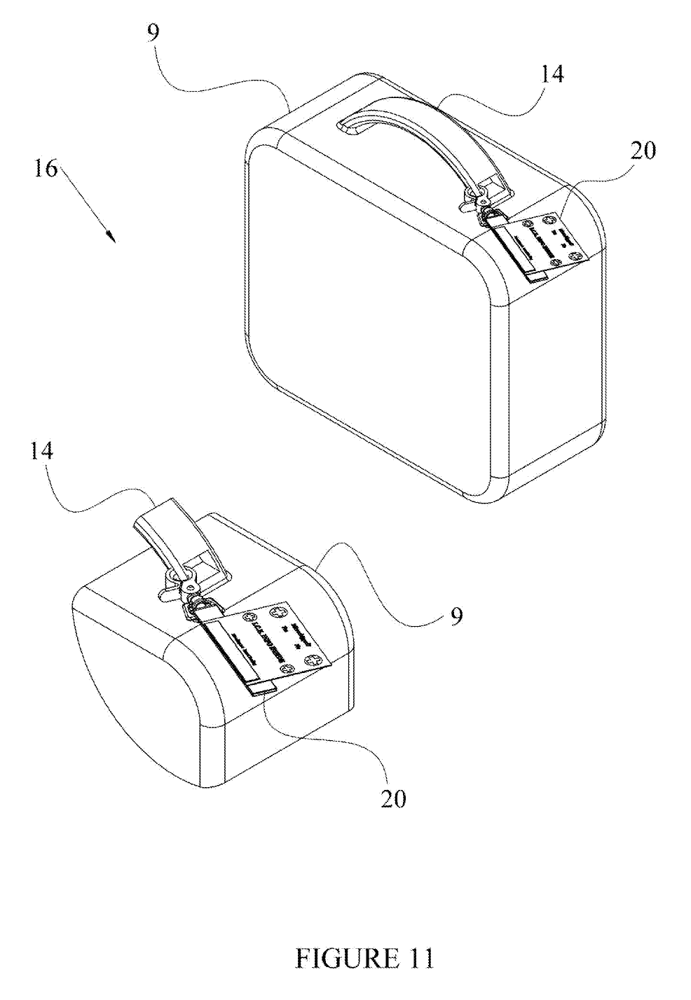

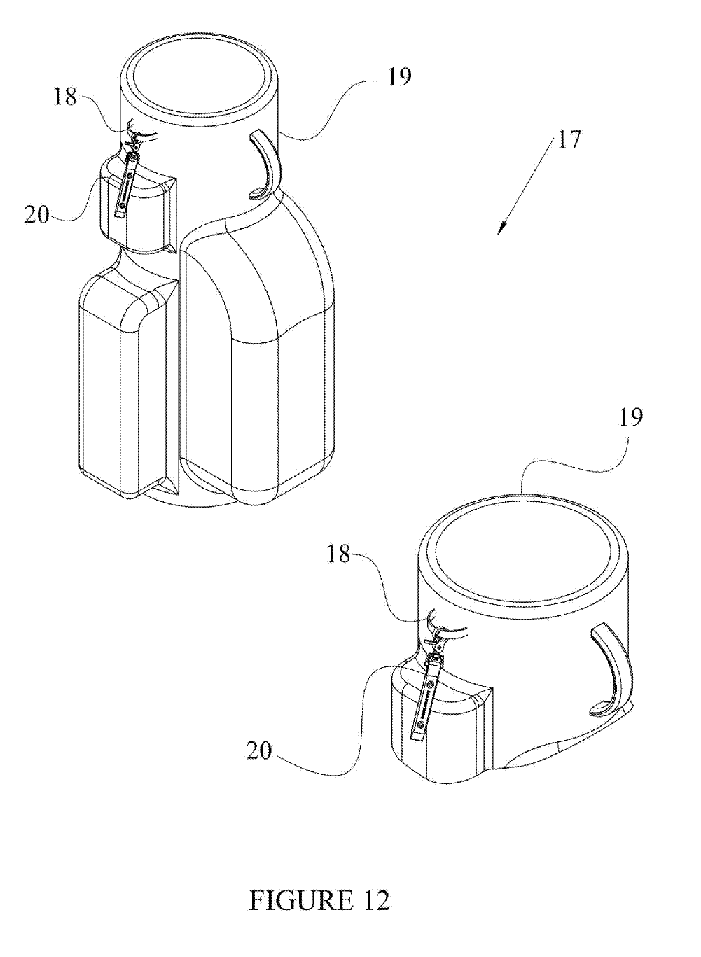

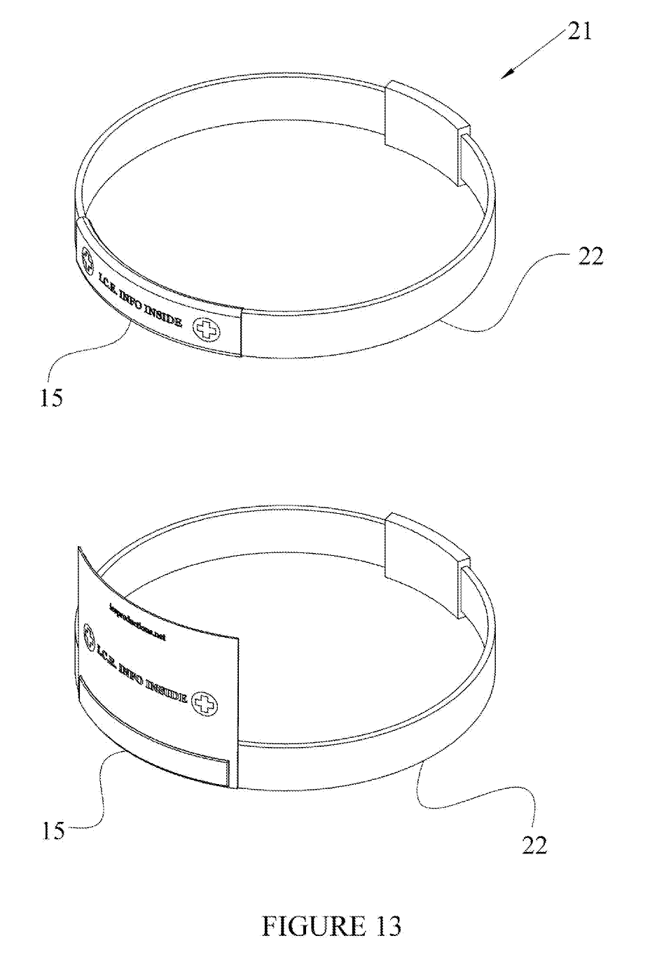

In the following detailed description of the preferred embodiment, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention. The present invention As shown in FIG. 1, could comprise a waterproof vinyl label 30 depicted in an identification clip-on tag (20), identification halter tag (15), an identification pet collar tag (21), identification luggage tag (16), identification sport tag (17) in additional to specialty tag for its operation as an essential identification tool. As generally shown in FIG. 2, such a waterproof vinyl label 30 could comprise of a nylon tag (10), made of ultra blockout banner pro 20 z material (11), a velcro tab attachment (4) including the product name (3), microchipped information (1), company web site (2), and important information (5). In halter version of the waterproof vinyl label 30 as substantially shown in FIG. 3, could comprise of a vinyl tag (10), made of ultra blockout banner pro 18 oz material (11), a Velcro tab attachment (4) including the product name (3), company web site (2) and important information (5). As substantially shown in FIG. 4, a front and back view of waterproof vinyl label 30 depicted in an identification clip-on emergency contact form (20), could comprise of a vinyl emergency contact form (10), a clip-on snap (12), attached to a braided nylon strap (6) and microchipped information (1). In addition, a company logo (13) could be applied to the front of the vinyl emergency contact form (10). As substantially shown in FIG. 5, is a front and back view of the clip-on emergency contact form (20) with the emergency contact form in the open position enabling the emergency contact form information (5) to be shown. The identification clip-on emergency contact form (20) could comprise of a vinyl emergency contact form (10), a clip-on snap (12), attached to a braided nylon strap (6), with the Velcro tab attachment (4) including the product name (3), microchipped information (1), and company web site (2). As best seen in FIG. 6, is an exploded view of the identification clip-on emergency contact form (20), showing the assembly of the vinyl emergency contact form (10), Clip-on hook (12), and the braided nylon strap (6). As substantially shown in FIG. 7, a front and back view of waterproof vinyl label 30 depicted in an identification halter emergency contact form (15), could comprise of a vinyl emergency contact form (10), a strap connector (8), attached to a horse harness halter strap (7), including the product name (3) and company web site (2). As substantially shown in FIG. 8, is a front and back view of the identification halter emergency contact form (15) with the emergency contact form in the open position enabling the emergency contact form information (5) to be shown. The identification halter emergency contact form (15) could comprise of a vinyl emergency contact form (10), a strap connector (8), attached to a horse harness halter strap (7), with the Velcro tab attachment (4) including the product name (3), and company web site (2). As best seen in FIG. 9, is an exploded view of the identification halter emergency contact form (15), showing the assembly of the vinyl emergency contact form (10), a strap connector (8), and the horse harness halter strap (7). As substantially shown in FIG. 10, a flow chart showing the possible uses of the identification clip-on emergency contact form (20) and best depicted in FIG. 11, and FIG. 12. As substantially shown in FIG. 11, an identification luggage emergency contact form (16) could comprise of luggage (9), identification clip-on emergency contact form (20), and attached to the luggage handle (14). As substantially shown in FIG. 12, identification sport emergency contact form (17) could comprise of golf bag (19), identification clip-on emergency contact form (20), and attached to the golf bag metal d-ring (18). As substantially shown in FIG. 13, a flow chart showing the possible uses of the identification halter emergency contact form (15).

What is claimed is:

1. An Identification tag comprising:
A. A portable lightweight durable vinyl folding label that is an essential identification tool for all animal owners, sports equipment users, and travelers with luggage
B. The identification tag comprising a label made of durable waterproof vinyl material with a front side having indicia thereon (FIG. 1b), and microchipped information
C. A tag material which is a flexible material of a bonded layer of vinyl material connected by heat sealing with a backside that will readily accept identification data and a porous indicia receiving material for receiving and displaying a permanent material.

3. An Identification tag comprising a label attached to a nylon strip so that the nylon strip and label are produced and distributed as a single item, with a clip on mechanism to be engaged to an object by being attached to one end of the nylon strip.

8. An Identification tag as claimed in claim 5, wherein identification tag sewn onto the halter, bridle, breast collar secures the important contact information to the animal.

11. An Identification tag as claimed in claim 1, wherein the label attached to a bracelet and held stationary against the bracelet to form a wristband.
